(19) United States
(12) Patent Application Publication
(10) Pub. No.: US 2006/0251270 A1
(43) Pub. Date: Nov. 9, 2006

(54) ANTI-POP DEVICE FOR AUDIO AMPLIFIERS

(76) Inventors: Cheng-Chung Yang, Tainan City (TW); Li-Ping Chu, Tainan City (TW); Tai-Haur Kuo, Tainan City (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(21) Appl. No.: 11/308,770

(22) Filed: May 2, 2006

(30) Foreign Application Priority Data
May 3, 2005 (TW) 94114248

(51) Int. Cl. H04B 15/00

(52) U.S. Cl. 381/94.5

(57) ABSTRACT

An anti-pop device for audio amplifier is suitable for outputting signals to a speaker to produce sound waves. The audio amplifier comprises a pre-processing unit, a filter and a voltage level detection unit electrically connected to the pre-processing unit. The voltage level detection unit detects the supply voltage. As the supply voltage is lower than a predetermined value, the voltage level detection unit outputs a signal to the pre-processing unit for lowering the audio volume so that a pop noise caused by circuit malfunction resulted from excessively-low supply voltage can be prevented.

### CROSS-REFERENCE TO RELATED APPLICATION

This application claims the priority benefit of Taiwan application serial no. 941 14248, filed on May 3, 2005. All disclosure of the Taiwan application is incorporated herein by reference.

### BACKGROUND OF THE INVENTION

1. Field of Invention

The present invention relates to an audio amplifier, and more particularly, to a digital audio power amplifier, which is capable of preventing pop-noise.

2. Description of the Related Art

Conventionally, class-A operational amplifier or a class-AB operational amplifier (referred to as class-A amplifier and class-AB amplifier) is employed in audio amplification. FIG. 1 is a schematic circuit diagram showing one of conventional analog audio amplifier. When the amplifier was shut down, a discharge circuit 10 formed by a parallel circuit of a capacitor C1 and a resistor R1 is used to discharge output audio signal to prevent the occurrence of pop-noise. However, because of the low power conversion efficiency, the two aforementioned audio amplifiers need a large scale or high efficiency heat sink plate or a radiator for heat dissipation when operating under high-power situation. Therefore, the hardware of the two aforementioned audio amplifiers is bulky and oversize.

Recently, class-D audio amplifiers are more and more popularly. Its high efficiency power conversion characteristic prevents the use of the large radiator and thus reduces hardware size. In addition, due to high power conversion efficiency, the class-D audio amplifier can provide a larger output power than the class-A or class-AB audio amplifier under the same operation voltage. The class-D audio amplifier can be roughly classified into two kinds; one is for processing analog input audio signal and the other is for processing digital input audio signal (briefly termed as a digital audio power amplifier). FIG. 2 is a block diagram of a conventional digital audio power amplifier. Referring to FIG. 2, the digital audio power amplifier comprises a signal input interface 11, an audio signal processor 12, a pulse-width modulator 13, a power amplifier 14 and a filter 15.

A digital audio signal is input via the signal input interface 11, and then volume adjusted and frequency equalized by the audio signal processor 12, then the processed signal outputs to the pulse-width modulator 13 to be modulated as a pulse-width modulation signal (PWM signal). Finally, the PWM signal is amplified by the power amplifier 14 and then filtered by the filter 15 and output to a speaker 16 to form a sound waves. Moreover, the filter 15 could be omitted and the signal could be input to the speaker 16 directly form the amplifier 14 to form sound waves.

Nevertheless, as a supply voltage of the aforementioned audio amplifier is excessively-low due to a shut down action or other factors, the signal input interface 11, the audio signal processor 12, the pulse-width modulator 13 and the power amplifier 14 would malfunction. So that the residual charges in the filter 15 and the speaker 16 would rush to the speaker 16 and discharge at a abnormal speed. Thus, pop-noise or cacophony is produced on the speaker 16. It is noted that the discharge circuit formed by the resistor R1 and the capacitor C1 in the conventional analog audio amplifier shown in FIG. 1 is not applicable to a digital audio amplifier.

### SUMMARY OF THE INVENTION

An object of the present invention is to minimize pop-noise in digital audio power amplifiers, which, by lowering audio volume to eliminate residual charges on the filter and speaker before the supply voltage is too low for normal operation.

An anti-pop audio amplifier of the present invention is suitable for outputting amplified audio signals to the speaker to give out sound waves and, in case of excessively-low supply voltage, for preventing the pop-noise from being output by the speaker. The anti-pop audio amplifier comprises a pre-processing unit and a voltage level detection unit being electrically connected to the pre-processing unit.

The pre-processing unit is used to receive an audio signal then process, modulate as well as power-amplify the signal, and then output the amplified signal to a speaker.

The voltage level detection unit is used for monitoring the supply voltage. As the supply voltage is lower than a predetermined value, the voltage level detection unit outputs a signal to the pre-processing unit for lowering audio volume to prevent pop-noise caused by circuit malfunction due to excessively-low supply voltage.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve for explaining the principles of the invention.

FIG. 1 is a schematic circuit diagram of a conventional analog audio amplifier with anti-pop mechanism by RC circuit.

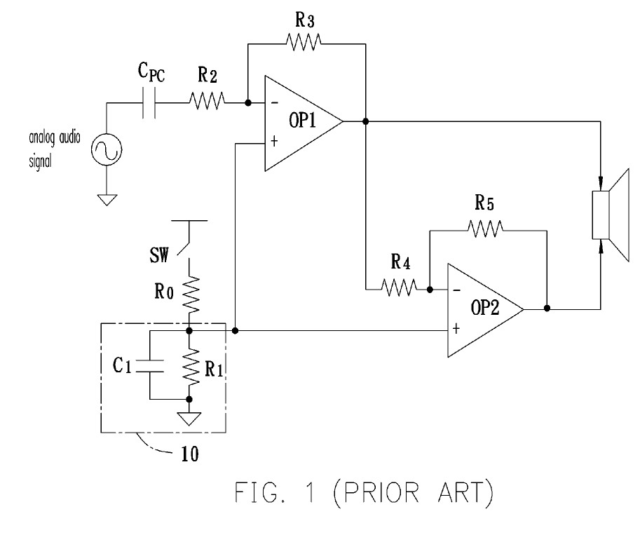

FIG. 2 is a block diagram of a conventional digital audio power amplifier.

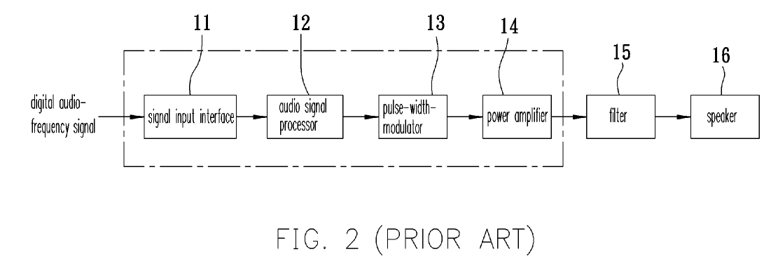

FIG. 3 is a block diagram of a digital audio amplifier with anti-pop mechanism according to the first embodiment of the present invention.

FIG. 4 is a schematic circuit diagram of a full-bridge power amplifier with a filter as disclosed in the first embodiment of the present invention.

FIG. 5 is a partial block diagram showing the configuration of a voltage level detection unit and its electrical connections according to the first embodiment of the present invention.

FIG. 6 illustrates the relations among the supply voltage, reference voltage and comparator output in the detection unit according to the first embodiment of the present invention.

FIG. 7 is a diagram showing the configuration of a voltage level detection unit according to the second embodiment of the present invention.

FIG. 8 illustrates the relations among the supply voltage, reference voltage, hysteresis supply voltage and logic circuit output in the detection unit according to the second embodiment of the present invention.

### DESCRIPTION OF THE EMBODIMENTS

It is noted that all the similar parts are labeled in the same number for better understanding of the context.

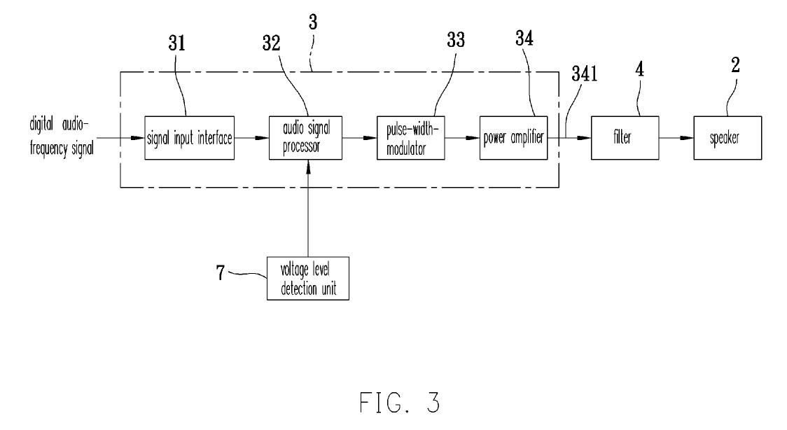

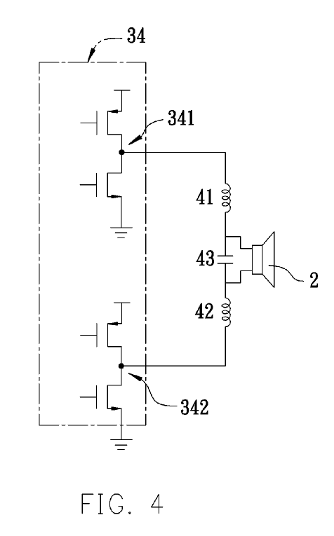

FIG. 3 is a block diagram of a digital audio amplifier with anti-pop mechanism according to the first embodiment of the present invention and FIG. 4 is a schematic circuit diagram of a full-bridge power amplifier with a filter in the first embodiment of the present invention. Referring to FIGS. 3 and 4, an amplifier with anti-pop mechanism provided by the first embodiment of the present invention is suitable for outputting audio signals to a speaker 2 and, as a supply voltage is lower than a predetermined value, for preventing the pop-noise caused by the excessive-low supply voltage from being output to the speaker 2. The amplifier with anti-pop mechanism comprises a pre-processing unit 3 for receiving an audio signal, processing the received audio signal with volume adjusting, modulating and power amplifying; a filter 4 for receiving the signal from the pre-processing unit 3 to remove the high-frequency noise in the received signal and then output the filtered signal to the speaker 2; and a voltage level detection unit 7 electrically connected to the pre-processing unit 3. Although the embodiment takes the digital audio signal processing as an example, but the described principle is applicable to an audio amplifier for processing analog audio signal so that the present invention does not limit to the digital audio signal processing.

The pre-processing unit 3 includes a signal input interface 31, an audio signal processor 32, a pulse-width modulator 33 and a power amplifier 34. The signal input interface 31 receives digital audio signal with various sampling frequencies and data formats, and then sending the received signal to an audio signal processor 32.

The audio signal processor 32 performs volume adjusting, mute control and other digital audio signal processing, then outputs a pulse-code-modulation signal (PCM signal) to the pulse-width modulator 33.

The pulse-width modulator 33 receives the PCM signal and modulates the received signal as a pulse-width-modulation (PWM) signal. The PWM is a conventional modulation technique, so that its description is omitted for simplicity.

The power amplifier 34 amplifies the PWM signal from the pulse-width modulator 33 and then outputs by the output terminals 341 and 342. The power amplifier 34 in FIG. 4 can be a full-bridge amplification circuit, a full-differential amplification circuit or other appropriate amplification circuit with two output terminals. The power amplifier 34 herein is a common circuit structure of the present invention, so that its description is omitted for simplicity.

The filter 4 is a low-pass filter to remove high-frequency noise in the signals from the output terminals 341 and 342 of the power amplifier 34. The filter 4 is mainly formed by two inductors 41 and 42 and a capacitor 43 that is connected in parallel with the speaker 2, wherein the inductors 41 and 42 and the capacitor 43 are connected in serial. The filtered signal is sent to the speaker 2 to produce sound waves. Although the sound waves produced by the speaker 2 is with the filter 4 in the embodiment, it can be produced directly by the output of the power amplifier 34. Moreover, the present invention does not limit to whether the filter 4 is employed.

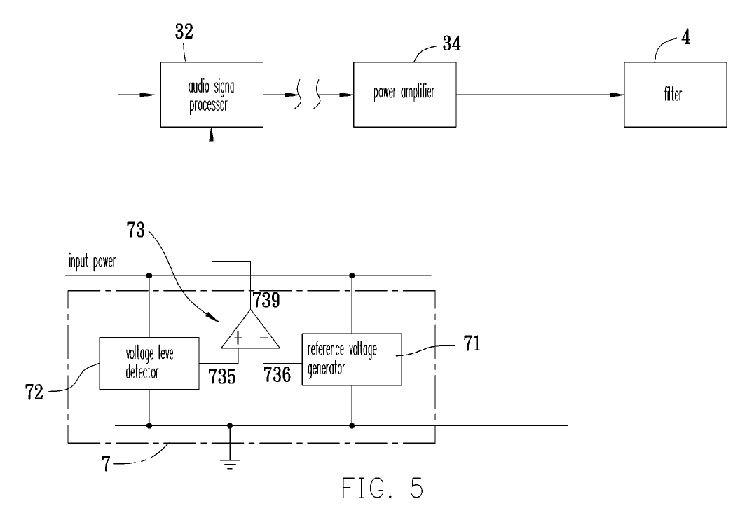

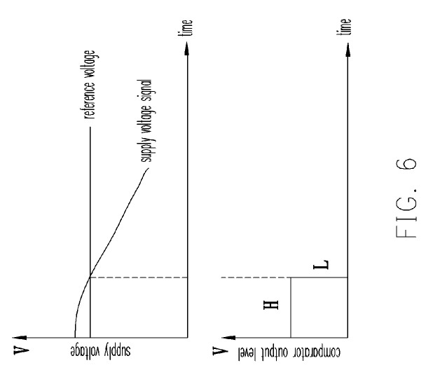

FIG. 5 is a partial block diagram showing the configuration of a voltage level detection unit and its electrical connections according to the first embodiment of the present invention, while FIG. 6 is a diagram showing the relations among the supply voltage, reference voltage and comparator output in the detection unit according to the first embodiment of the present invention. Referring to FIG. 5, the voltage level detection unit 7 has a reference voltage generator 71 electrically connected to the supply voltage and outputs a reference voltage signal, a voltage level detector 72 detects the supply voltage and outputs a voltage signal to a comparison component 73 for comparing the supply voltage with the reference voltage signal. The reference voltage signal is constant regardless of the supply voltage variation, while the supply voltage variation would affect the voltage signal, i.e., there is a proportion factor between the voltage signal and the supply voltage. In the embodiment, the reference voltage signal from the reference generator 71 is adjustable to fit various supply voltage ranges for different applications.

Referring to FIG. 5 and FIG. 6, the comparison component 73 is comprised of a comparator and has a positive input terminal 735 for receiving the supply voltage signal, a negative input terminal 736 for receiving the reference voltage signal and an output terminal 739. The circuit of the comparison component 73 is a conventional technology, so that its description is omitted for simplicity. Under normal conditions, the supply voltage level is higher than the reference voltage signal, thus, at the output terminal 739 of the comparison component 73 is a high-level voltage output to the pre-processing unit 3 to keep the audio signal processor 32 at a normal operation. Once the supply voltage drops down and is lower than the reference voltage signal, at the output terminal 739 of the comparison component 73 is a low-level voltage output to the pre-processing unit 3 to drive the audio signal processor 32 to lower the volume. Furthermore, the power amplifier 34 stops to output when the audio volume is at the minimum level. Only when the input power restores a normal state, the comparison component 73 resumes to output the high-level voltage to the pre-processing unit 3, so that the audio signal processor 32 resumes to normal operation.

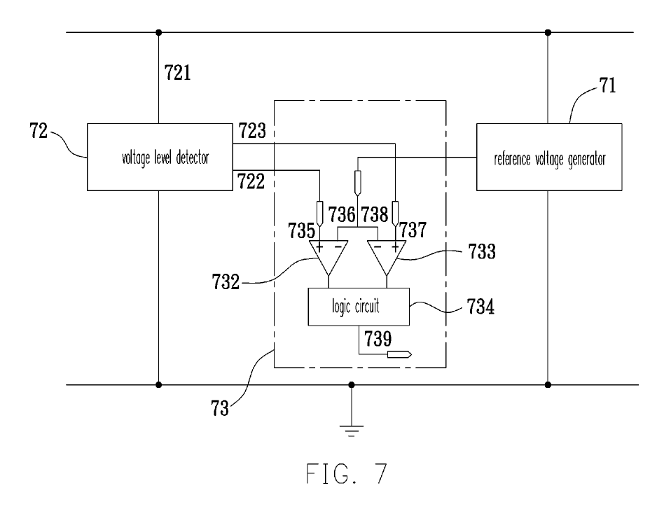

FIG. 7 is a diagram showing the configuration of a voltage level detection unit according to the second embodiment of the present invention. Referring to FIG. 3 and FIG. 7, the second embodiment of the present invention is similar to the first embodiment, except that the voltage levels for deciding whether the input voltage is an excessively-low voltage and whether the input voltage level is restored to a normal operating voltage. In response thereto, the voltage level detector 72 has an input terminal 721 for detecting the supply power, a first output terminal 722 for outputting a voltage signal and a second output terminal 723 for outputting a hysteresis voltage signal. Under normal conditions, the level of the supply voltage is higher than the hysteresis voltage signal, while the level of the hysteresis voltage signal is higher than the reference voltage signal.

In addition, the comparison component 73 is formed by a first comparator 732, a second comparator 733 and a logic circuit 734 for receiving the output signals from the two comparators 732 and 733. A negative input terminal 736 of the first comparator 732 and a negative input terminal 738 of the second comparator 733 are electrically connected to receive the reference voltage signal, a positive input terminal 735 of the first comparator 732 is electrically connected to a first output terminal 722 of the voltage level detector 72 for receiving the supply voltage signal, and a positive input terminal 737 of the second comparator 733 is electrically connected to a second output terminal 723 of the voltage level detector 72 for receiving the hysteresis voltage signal. The logic circuit 734 processes the output signals from the first comparator 732 and the second comparator 733 and decides whether to produce a control signal, via an output terminal 739, to the pre-processing unit 3 to lower the audio volume level.

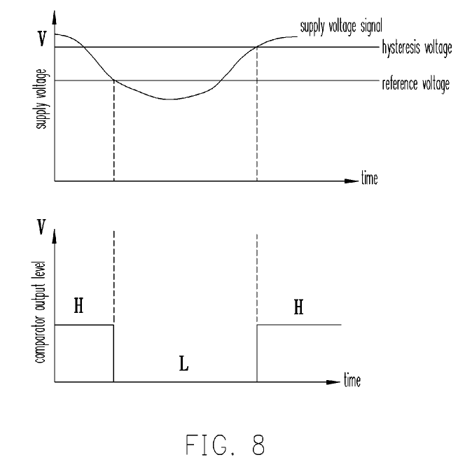

FIG. 8 is a diagram showing the relations among the supply voltage, reference voltage, hysteresis supply voltage and logic circuit output in the detection unit according to the second embodiment of the present invention. Referring to FIG. 8, if the supply voltage is too low to cause the level of the voltage signal lower than the reference voltage signal, the logic circuit 734 of the comparison component 73 outputs a low-level voltage to drive the pre-processing unit 3 for lowering audio volume level to prevent pop-noise. Only when the supply voltage rises to a level higher than the hysteresis voltage signal, the logic circuit 734 of the comparison component 73 starts to output a high-level voltage to drive the pre-processing unit 3 to resume normal operation. As such, the second embodiment can prevent the output signal of the comparison component 73 from fluctuation due to the supply voltage fluctuates or has electric noise, which further prevents the audio volume level from being fluctuated. Besides, procedures for detecting voltage status through the voltage level detection unit 7 and then lowering the audio volume level are done before the circuit malfunctioned due to the excessively-low supply voltage so as to prevent pop-noise.

In summary, the voltage level detection unit 7 is employed in the anti-pop device for audio amplifiers of the present invention to monitor the status of the supply voltage, wherein as the supply voltage drops due to a shut down action or other abnormal factors, the voltage level detection unit 7 immediately drives the audio signal processor 32 of the pre-processing unit 3 to lower the audio volume level, so that the residual charges in the filter 4 and speaker 2 are eliminated. Further, as the audio volume is at the minimum level, the power amplifier 34 stops outputting for preventing pop-noise.

It will be apparent to those skilled in the art that various modifications and equivalent variations can be made to the structure of the present invention without departing from the scope or spirit of the invention. In view of the foregoing, it is intended that the specification and examples to be considered as exemplary only, with a true scope and spirit of the invention being indicated by the following claims and their equivalents.

What is claimed is:

1. An anti-pop audio amplifier, suitable for outputting signals to a speaker to produce sound waves and for lowering audio volume to prevent pop-noise at the speaker when the supply voltage is lower than a predetermined value; the audio amplifier comprising:
a pre-processing unit, used for receiving an audio signal, adjusting audio volume level of the signal, modulating the signal, performing power amplification and then sending the amplified signal to the speaker to produce sound waves;
a voltage level detection unit, used for monitoring the supply voltage, wherein as the supply voltage is lower than a predetermined value, the voltage level detection unit outputs a signal to the pre-processing unit to lower the audio volume level for eliminating residual charges, so as to prevent the pop-noise caused by the excessively-low supply voltage.

2. The anti-pop audio amplifier as claimed in claim 1, wherein the voltage level detection unit has a reference voltage generator electrically connected to the supply voltage and outputting a reference voltage signal, and a comparison component for comparing the supply voltage signal with the reference voltage signal, wherein the reference voltage signal is constant regardless of the variation of supply voltage variation, as the supply voltage is lower than the reference voltage signal, the comparison component outputs a signal to the pre-processing unit for lowering the audio volume level.

3. The anti-pop audio amplifier as claimed in claim 2, wherein the voltage level detection unit further comprises a voltage level detector for detecting the supply voltage and outputting a voltage signal to the comparison component, and the comparison component compares the received voltage signal with the reference voltage signal from the reference voltage generator to decide whether the supply voltage is excessively low.

4. The anti-pop audio amplifier as claimed in claim 3, wherein the comparison component is formed by at least a comparator.

5. The anti-pop audio amplifier as claimed in claim 4, wherein the comparison component has a positive input terminal for receiving the supply voltage, a negative input terminal for receiving the reference voltage and an output terminal; under normal conditions, the supply voltage is higher than the reference voltage signal, the output terminal outputs a high-level voltage to the pre-processing unit to keep the audio signal processor at a normal operation; as the supply voltage drops and is lower than the reference voltage signal, the output terminal outputs a low-level voltage to drive the audio signal processor for lowering the audio volume level.

6. The anti-pop audio amplifier as claimed in claim 3, wherein the voltage level detector further outputs a hysteresis voltage signal with a level higher than the reference voltage signal; as the supply voltage is higher than the hysteresis voltage signal and the reference voltage signal, the pre-processing unit is in normal state; as the input supply voltage fluctuates to be lower than the reference voltage signal, the comparison component outputs a signal to drive the pre-processing unit for lowering the audio volume level to prevent the pop noise; if the supply voltage rises to a level higher than the hysteresis voltage signal, the comparison component outputs a signal to drive the pre-processing unit to resume the normal operation.

7. The anti-pop audio amplifier as claimed in claim 6, wherein the comparison component is consisted of a first comparator, a second comparator and a logic circuit for receiving the output signals from both comparators, each of the first and the second comparators has a positive input terminal, a negative input terminal and an output terminal;
the negative input terminal of the first comparator and the negative input terminal of the second comparator are electrically connected for receiving the reference voltage signal; the positive input terminal of the first comparator and the positive input terminal of the second comparator receive the supply voltage and the hysteresis voltage signal from the voltage level detector, respectively; as the supply voltage is lower than the reference voltage signal, the logic circuit outputs a low-level voltage to drive the pre-processing unit for lowering the audio volume level to prevent the pop noise; if the supply voltage rises to a level higher than the hysteresis voltage signal, the logic circuit outputs a high-level voltage to drive the pre-processing unit to resume the normal operation.

8. The anti-pop audio amplifier as claimed in claim 2, wherein the reference voltage signal output from the reference voltage generator is adjustable to fit various voltage ranges.

9. The anti-pop audio amplifier as claimed in claim 1, wherein the pre-processing unit has a signal input interface and an audio signal processor for receiving the audio signal, adjusting the volume level of the signal, and then outputting a pulse-code-modulation signal (PCM signal), a pulse-width modulator for receiving the PCM signal from the audio signal processor to modulate a pulse-width-modulation signal (PWM signal), and a power amplifier for amplifying the PWM signal from the pulse-width modulator, and then outputting the amplified signal.

10. The anti-pop audio amplifier as claimed in claim 9, wherein the audio signal processor of the pre-processing unit performs the audio volume adjustment when the low voltage variation is detected, and once the volume is at the minimum level, the power amplifier stops outputting.

11. The anti-pop audio amplifier as claimed in one of claims 1 to 10, further comprises a filter can be used to remove the high frequency noise.
